(19) United States
(12) Patent Application Publication
(10) Pub. No.: US 2002/0035505 A1
(43) Pub. Date: Mar. 21, 2002

(54) Mobile communication method and apparatus using backscattering of carrier

(76) Inventors: Wan-Chol Ho, Bucheon-city (KR); Seung-Ho Choi, Seoul (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/945,051

(22) Filed: Aug. 31, 2001

(30) Foreign Application Priority Data
Sep. 19, 2000 (KR) 00-54865

(51) Int. Cl. G06F 17/60

(52) U.S. Cl. 705/13

(57) ABSTRACT

A mobile communication apparatus and method using backscattering of a carrier is provided. The mobile communication apparatus includes a mobile station including a mobile station communication controller for processing data including control data to output a predetermined data frame, a mobile station source coder for receiving the data frame and performing source coding on it according to a predetermined coding method to output coded data, a first modulator for receiving a first carrier having a predetermined frequency and modulating the coded signal from the mobile source coder using the first carrier to generate a first modulated signal, a second modulator for receiving a second carrier having a predetermined frequency and performing modulation on the first modulated signal using the second carrier to generate a modulated uplink signal, a mobile station interfacer for transmitting the modulated uplink signal to the base station and receiving a modulated downlink signal from the base station, a first demodulator for receiving and demodulating the modulated downlink signal received from the base station via the mobile station interfacer and outputting demodulated data, and a mobile station source decoder for performing source decoding on the demodulated data from the first demodulator to convert the demodulated data to a baseband signal. Accordingly, high speed data communication can be realized, and the necessity of a special data pattern necessary for frame synchronization can be removed. Since the mobile station performs amplitude shift keying (ASK) modulation using a carrier received from a base station after performing differential phase shift keying (DPSK) modulation, it does not requires a separate oscillator so that hardware configuration can be simplified. Consequently, the mobile station can be economically manufactured.

### BACKGROUND OF THE INVENTION

1. Field of the Invention

The present invention relates to a mobile communication apparatus and method through which a mobile station generates a modulated signal using a carrier provided from a base station for communication between the base station and the mobile station.

2. Description of the Related Art

In conventional transmission from a mobile station to a base station, binary phase shift keying modulation is applied to low speed data (of at most several hundreds of kbps). Here, when data is transmitted at high speed (of at least 1 Mbps), the probability that the data has an error due to a change in a phase occurring when the data is demodulated is very high. In constructing a mobile communication system such as an electronic toll collecting system, high speed data transmission between a base station and a mobile station is required. However, when high speed data which has been transmitted from a vehicle moving fast to a base station is demodulated, the probability that the phase of demodulated digital data is changed resulting errors is very high. Accordingly, when a conventional electronic toll collecting system is used, there is a disadvantage of installing a crossing gate at a tollgate or intentionally making a vehicle detour to drop the speed of the vehicle.

### SUMMARY OF THE INVENTION

To solve the above problems, it is a first object of the present invention to provide a mobile station for primarily modulating high speed data using differential phase shift keying, secondarily performing amplitude shift keying modulation on the primarily modulated data based on a carrier provided from a base station, transmitting a modulated uplink signal to the base station, receiving an amplitude shift keying modulated downlink signal from the base station and reconstructing and processing original data, and a communication method for the same.

It is a second object of the present invention to provide a base station for transmitting amplitude shift keying modulated data to a mobile station, transmitting only a carrier to the mobile station for a predetermined time while there is no data, and demodulating a modulated uplink signal received from the mobile station by performing mixing and filtering to reconstruct original data, and a communication method for the same.

It is a third object of the present invention to provide an electronic toll collecting system composed of the base station and the mobile station, in which various data including a toll can be communicated between the base station and the mobile station without making a vehicle stop or reduce the speed at a tollgate on a toll road such as an expressway, and a method thereof.

Accordingly, to achieve the first object of the invention, there is provided a mobile station including a mobile station communication controller for processing data including control data to output a predetermined data frame, a mobile station source coder for receiving the data frame and performing source coding on it according to a predetermined coding method to output coded data, a first modulator for receiving a first carrier having a predetermined frequency and modulating the coded signal from the mobile source coder using the first carrier to generate a first modulated signal, a second modulator for receiving a second carrier having a predetermined frequency and performing modulation on the first modulated signal using the second carrier to generate a modulated uplink signal, a mobile station interfacer for transmitting the modulated uplink signal to the base station and receiving a modulated downlink signal from the base station, a first demodulator for receiving and demodulating the modulated downlink signal received from the base station via the mobile station interfacer and outputting demodulated data, and a mobile station source decoder for performing source decoding on the demodulated data from the first demodulator to convert the demodulated data to a baseband signal.

There is also provided a communication method performed by a mobile station. The communication method includes the steps of processing data including control data to form a predetermined mobile station information data frame, coding the mobile station information data frame according to a predetermined source coding method and performing primary modulation on the coded data frame using a predetermined first carrier according to a first predetermined modulation/demodulation method, performing secondary modulation on the primarily modulated signal using a predetermined second carrier according to a second predetermined modulation/demodulation method and transmitting the secondarily modulated signal to the base station, demodulating a modulated downlink signal transmitted from the base station according to the second predetermined modulation/demodulation method and generating the demodulated signal as a source coded signal, and decoding the source coded signal according to a predetermined source decoding method to reconstruct original data.

To achieve the second object of the invention, there is provided a base station including a base station communication controller for processing data including control data to output a predetermined data frame, a base station interfacer for receiving a modulated uplink signal from the mobile station and transmitting a modulated downlink signal to the mobile station, a mixer for mixing the modulated uplink signal with a predetermined intermediate frequency and filtering the mixed signal to convert the modulated uplink signal to a signal having the predetermined intermediate frequency, an oscillator for generating the predetermined intermediate frequency, a base station demodulator for demodulating the output signal of the mixer to generate a baseband signal according to a predetermined demodulation method, a base station source decoder for receiving the baseband signal from the base station demodulator and performing source decoding according to a predetermined method, a base station source coder for performing source coding the data frame output from the base station communication controller, and a base station modulator for modulating the output data of the base station source coder according to a predetermined method and outputting modulated data to the base station interfacer.

There is also provided a communication method performed by a base station. The communication method includes the steps of receiving a modulated uplink signal transmitted from the mobile station to the base station, mixing the modulated uplink signal with a predetermined intermediate frequency, and filtering the mixed signal to generate an intermediate signal having the predetermined intermediate frequency; demodulating the intermediate signal according to a predetermined demodulation method to generate a baseband signal; source-decoding the baseband signal according to a predetermined method to reconstruct original data received from the mobile station; processing data including control data to form a data frame and source-coding the data frame; and modulating the source coded data frame according to a predetermined method and transmitting the modulated signal to the mobile station.

To achieve the third object of the invention, there is provided an electronic toll collecting system including a mobile station and a base station. The mobile station includes a mobile station communication controller for processing control data and information including start place information and balance to form and output a mobile station information data frame, receiving base station information data including destination information and billing information from the base station, and recalculating and updating the balance; a mobile station source coder for receiving the mobile station information data frame and performing source coding on it according to a predetermined coding method to output coded data; a first modulator for receiving a first carrier having a predetermined frequency and modulating the coded signal from the mobile source coder using the first carrier to generate a first modulated signal; a second modulator for receiving a second carrier having a predetermined frequency and performing modulation on the first modulated signal using the second carrier to generate a modulated uplink signal; a mobile station interfacer for transmitting the modulated uplink signal to the base station and receiving a modulated downlink signal from the base station; a first demodulator for receiving and demodulating the modulated downlink signal received from the base station via the mobile station interfacer and outputting demodulated data; and a mobile station source decoder for performing source decoding on the demodulated data from the first demodulator to generate a baseband signal and transmitting the baseband signal to a base station communication controller. The base station includes a base station interfacer for receiving a modulated uplink signal from the mobile station and transmitting a modulated downlink signal to the mobile station; a mixer for mixing the modulated uplink signal with a predetermined intermediate frequency and filtering the mixed signal to generate a signal having the predetermined intermediate frequency; an oscillator for generating the predetermined intermediate frequency; a base station demodulator for demodulating the output signal of the mixer to generate a baseband signal; a base station source decoder for receiving the baseband signal from the base station demodulator and performing source decoding according to a predetermined method; a base station communication controller for analyzing the mobile station's information data which is decoded and output by the base station source decoder to calculate a toll and processing data link layer control data and base station information data including destination information and billing data to form and output a predetermined base station information data frame; a base station source coder for performing source coding the base station information data frame; and a base station modulator for modulating the output data of the base station source coder according to a predetermined method and outputting modulated data to the base station interfacer.

### BRIEF DESCRIPTION OF THE DRAWINGS

The above objects and advantages of the present invention will become more apparent by describing in detail preferred embodiments thereof with reference to the attached drawings in which:

FIG. 1A is a block diagram illustrating a mobile station according to the present invention;

FIG. 1B is a block diagram illustrating a base station according to the present invention;

FIG. 2 is a detailed block diagram illustrating the base station demodulator of FIG. 18;

FIG. 3 is a flowchart illustrating a method of uplink communication from a mobile station to a base station;

FIG. 4 is a flowchart illustrating a method of downlink communication from a base station to a mobile station;

FIG. 5A is a diagram illustrating the data format of a downlink signal; and

FIG. 5B is a diagram illustrating the data format of an uplink signal.

### DETAILED DESCRIPTION OF THE PRESENT INVENTION

Hereinafter, embodiments of the present invention will be described in detail with reference to the attached drawings. To meet the convenience of a description, a modulated signal transmitted from a mobile station to a base station is referred to as a modulated uplink signal, and a modulated signal transmitted from the base station to the mobile station is referred to as a modulated downlink signal. The present invention will be described according to the flow of a signal.

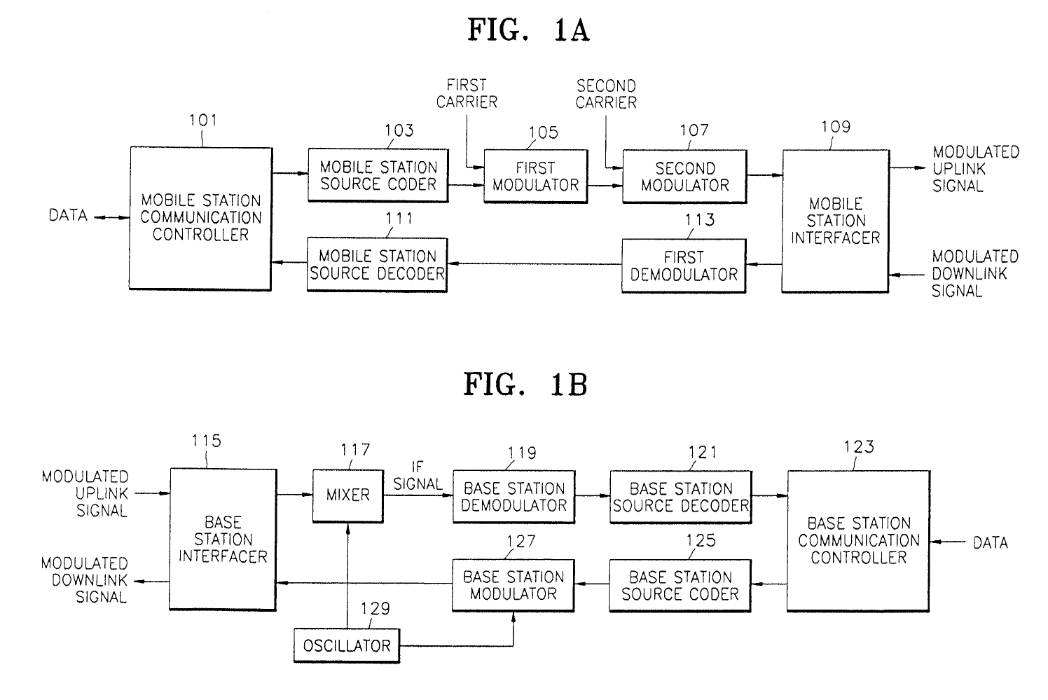

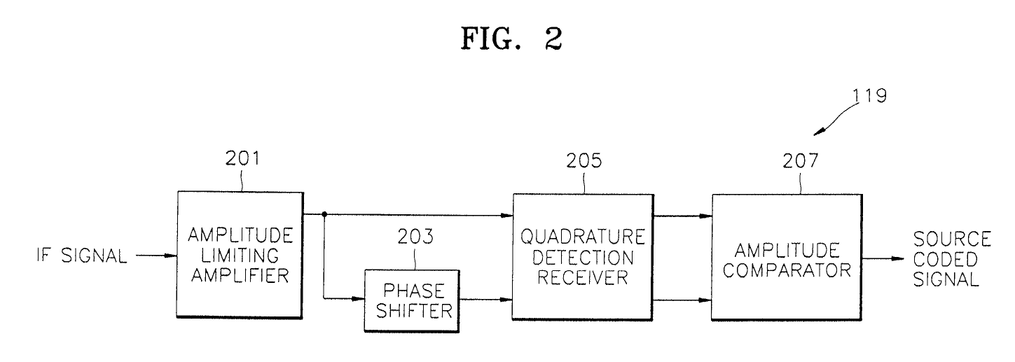

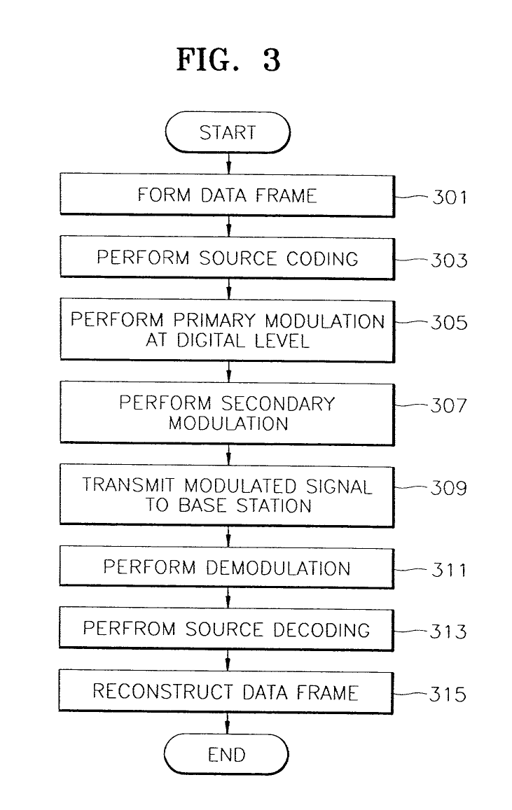

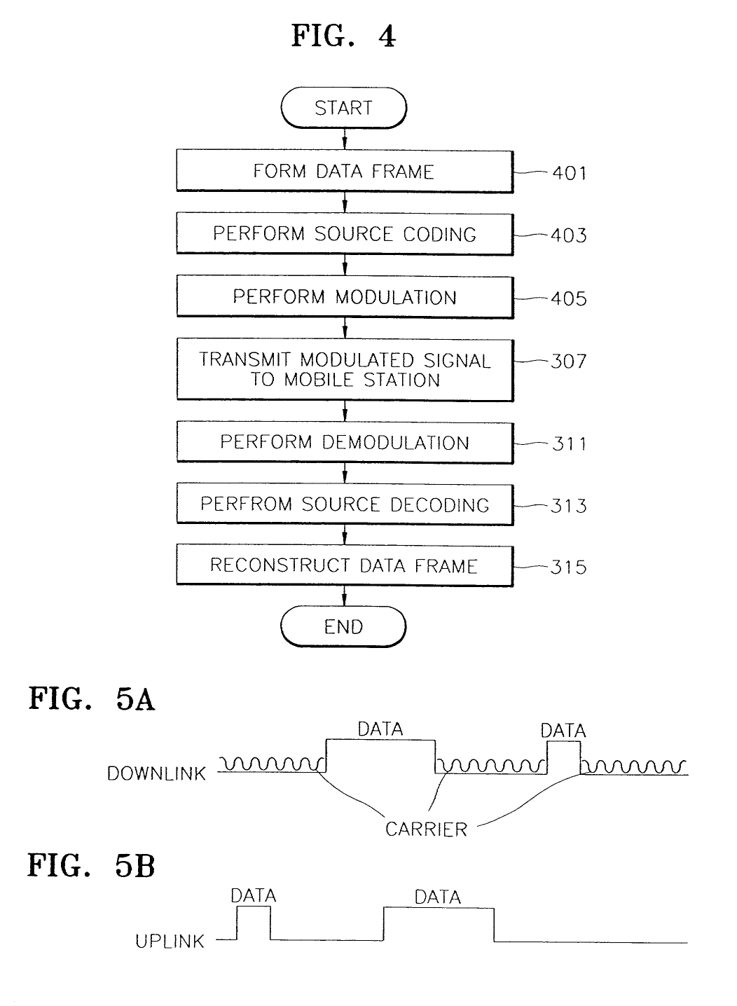

FIG. 1A is a block diagram illustrating a mobile station according to the present invention. FIG. 1B is a block diagram illustrating a base station according to the present invention. FIG. 2 is a detailed block diagram illustrating the base station demodulator of FIG. 1B. FIG. 3 is a flowchart illustrating a method of uplink communication from the mobile station of FIG. 1A to the base station of FIG. 1B. FIG. 4 is a flowchart illustrating a method of downlink communication from the base station of FIG. 1B to the mobile station of FIG. 1A. FIG. 5A is a diagram illustrating the data format of a downlink signal. FIG. 5B is a diagram illustrating the data format of an uplink signal.

In step 301, a mobile station communication controller 101 processes various information data including control data and forms a predetermined data frame having a predetermined speed (for example, of 1 Mbps). Here, the information data includes information such as the starting place of a vehicle with a mobile station and balance information necessary for collecting a toll. In step 303, the data frame is input to a mobile station source coder 103, coded according to Manchester encoding and then output. Since the Manchester encoding allows self-synchronization of signals, a separate preamble or postamble is not necessary. In step 305, a first modulator 105 digital-modulates the data, which has been coded according to the Manchester encoding, according to differential phase shift keying (DPSK) modulation based on a first carrier (for example, of 10 Mbps) internally generated in the mobile station. More specifically, after synchronizing the coded signal with the first carrier, the first modulator 105 generates a DPSK modulated signal through comparison of the phase of the coded signal and the phase of the first carrier. This first modulation is performed in order to allow the modulated data to be easily demodulated in a base station. In step 307, the DPSK modulated signal is input into a second modulator 107 and amplitude shift keying (ASK) modulated based on a second carrier so that it is output as a modulated uplink signal. Here, the second carrier is not generated within the mobile station but is received from the base station. When generating a modulated uplink signal with such an arrangement, the mobile station communicates with the base station in a manual mode where a special oscillator is not necessary. Accordingly, a hardware configuration can be simplified.

A method through which a base station provides the second carrier to a mobile station will be described with reference to FIG. 5A. FIG. 5A shows the waveform of a modulated downlink signal. As shown in FIG. 5A, after transmitting data for a predetermined time, the base station transmits only a carrier which is not modulated to a mobile station while waiting for a response from the mobile station. This carrier signal is used as the second carrier in the mobile station, and this is referred to as backscattering. Here, when a mobile station intending to use the carrier signal is within the communication area of the base station, the mobile station recognizes a downlink signal and immediately responses.

In step 309, the modulated uplink signal is transmitted to the base station through a mobile station interfacer 109 in a wireless or wired mode. A base station interfacer 115 receives the modulated uplink signal, processes the signal using an appropriate method (for example, when the base station communicates with the mobile station in a wireless mode, the base station interfacer 115 converts a received wireless signal into an electric signal), and outputs the result signal to a mixer 117. The mixer 117 mixes the output signal of the base station interfacer 115 with a sine wave signal, which is generated by an oscillator 129 and has a predetermined frequency, and filters the result signal to remove a carrier. The carrier removed signal is a signal having an intermediate frequency (IF) of an analog form (hereinafter, referred to as an IF signal), which is similar to the DPSK modulated signal in the mobile station. The base station demodulator 119 receives the IF signal and reconstructs the data before being DPSK modulated in the mobile station.

The detailed block diagram of the base station demodulator 119 is shown in FIG. 2. The functions of the base station demodulator 119 will be described with reference to FIG. 2. The IF signal is input to an amplitude limiting amplifier 201. The amplitude limiting amplifier 201 removes noise generated on the transmission path between the base station and the mobile station and outputs a corrected stable signal having a uniform amplitude. The output signal of the amplitude limiting amplifier 201 is input to both a quadrature detection receiver 205 and a phase shifter 203. The phase shifter 203 shifts the signal by a predetermined phase (for example, 90 degrees) and outputs the result signal to the quadrature detection receiver 205. A quadrature phase detector in the quadrature detection receiver 205 multiplies the two input signals and outputs the phase difference between the two signals. A signal indicating the phase difference is filtered by a low-pass filter so that the variation of voltage is output. An amplitude comparator receives the variation of voltage and a predetermined reference value having the direct current component of an original signal and compares their amplitudes. In other words, when the variation of voltage exceeds the reference value, a logic value 1 is generated. When the variation of voltage is smaller the reference value, a logic value 0 is generated. Consequently, the output signal of the amplitude comparator 207 has the same data waveform as the Manchester encoded data received from the mobile station, in step 311. Here, although usual frequency shift keying (FSK) demodulation can be used, the base station demodulator 119 can have simple hardware configuration and can be reliable in the presence of external noise since the Manchester encoded data is DPSK modulated based on the first carrier having the predetermined frequency in the present invention. Particularly, the influence of external noise or a change in an amplitude which can be generated on the transmission path between the base station and the mobile station can be minimized. The DPSK modulation of the present invention is expressed by Equation (1) and uses a single frequency, so that it can be easily implemented in a digital mode and is suitable for communication apparatuses reusing frequency.

s(t)=A cos 2π(ƒ₁+T) (1)

Here, ƒ₁ is the frequency of the first carrier, and T is 0° or 180°.

In addition, usual ASK modulation is easily influenced by an interference signal or the like, but a quadrature detection receiving method according to the present invention, which detects the phase difference between an original signal and a signal whose phase is shifted from the phase of the original signal, is reliable even if an amplitude changes or a frequency changes due to an interference signal. Accordingly, the present invention minimizes external influence and realizes high speed communication (for example, of at least 1 Mbps) in a manual mode where a carrier transmitted from a base station is reused.

The data demodulated by the base station demodulator 119 is data which has been coded according to the Manchester coding method, so, in step 313, a base station source decoder 121 decodes the demodulated data to reconstruct data before being source-coded. As a result of the decoding, the data frame which has been output from the mobile station communication controller 101 is reconstructed in step 315. A base station communication controller 123 receives the decoded data frame, reads information such as the starting place information of the mobile station and balance information, calculates a toll and extracts data link layer control data to determine whether an error occurred or not. The flow of a modulated uplink signal from a mobile station to a base station has been described. The format of the modulated uplink signal is shown in FIG. 5B. In the modulated uplink signal, modulated data is transmitted only when there is data.

The following description concerns the flow of a modulated downlink signal from the base station to the mobile station. In step 401, the base station communication controller 123 packetizes data containing information such as destination information and billing information and the data link layer control data to form a data frame of a predetermined format. In step 403, a base station source coder 125 receives the data frame and performs source coding according to the Manchester coding method. The output signal of the base station source coder 125 is input to a base station modulator 127. In step 405, the base station modulator 127 performs ASK modulation on the signal output from the base station source coder 125 using a carrier provided from the oscillator 129. Here, the ASK modulated signal is mixed with the carrier and then output to the base station interfacer 115 in the format of FIG. 5A described before. In step 407, the base station interfacer 115 transmits a modulated downlink signal in which the ASK modulated signal is mixed with the carrier to the mobile station in a wireless or wired mode. The modulated downlink signal is transmitted to the mobile station via the transmission path between the base station and the mobile station in the format of FIG. 5A. The mobile station interfacer 109 receives the modulated downlink signal and converts it to a signal having a format appropriate for processing (for example, when the modulated downlink signal from the base station is a wireless signal, the modulated downlink signal is converted into an electric signal). In step 409, a first demodulator 113 in the mobile station extracts the carrier from the received signal and demodulates the carrier removed signal to reconstruct data before being ASK modulated. As described before, the extracted carrier is used as the second carrier in the second modulator 107 so that a separate oscillator is not necessary. Meanwhile, since the demodulated data has been source coded according to the Manchester coding method, a mobile station source decoder 111 decodes the demodulated data in step 411 and reconstructs an original digital data frame (a baseband signal) in step 413. The reconstructed data frame is input to the mobile station communication controller 101. The mobile station communication controller 101 reads the received data frame to analyze information sent from the base station and updates its own database according to the result of the analysis.

In the embodiment described above, the base station and the mobile station is combined to meet the convenience of the descriptions of the apparatuses of a base station and a mobile station and the communication method therebetween.

As another embodiment of the combination of a base station and a mobile station, an electronic toll collecting system will be described below. As mentioned before, the electronic toll collecting system is provided for automatically collecting a toll on a charged road such as an expressway. To realize the electronic toll collecting system, a mobile station should be mounted on a vehicle, a base station should be installed at a tollgate, and high speed data communication should be performed between the mobile station and the base station. In addition, the probability that an error occurs in the data communication between the mobile station mounted on a vehicle moving at high speed and the base station should be low. Accordingly, the communication apparatuses and method according to the present invention described above is proper to such an electronic toll collecting system. Here, the mobile station communication controller 101 and the base station communication controller 115 have additional functions, but the remaining members and functions can be applied in the same manners as described above. Thus, a redundant description will be removed in describing the configuration of an electronic toll collecting system according to the present invention.

To automatically collect an electronic toll, starting place information should be input to a mobile station mounted on a vehicle at a starting place. This input operation is performed through the communication of information between the mobile station and a base station at the starting place. The mobile station communication controller 101 packetizes information including starting place information and information on the balance which can be payed for a toll and data link layer control data to form a data frame. Here, the balance information is stored in, for example, a recording device installed in the mobile station in the form of a smart card. Once the vehicle having the mobile station reaches a destination, the mobile station recognizes a signal transmitted from a base station at the destination.

The mobile station performs DPSK modulation first and then performs ASK modulation on the data frame. The result signal is transmitted as a modulated uplink signal to the base station at the destination.

The base station at the destination receives the modulated uplink signal and performs demodulation and source decoding on the modulated uplink signal to reconstruct an original data frame. The reconstructed data frame is input to the base station communication controller 123. The base station communication controller 123 reads passage information, which is transmitted from the mobile station mounted on the moving vehicle, from the reconstructed data frame and calculates a toll based on the read information. Then, the base station communication controller 123 packetizes calculated toll information, other information and data link layer control data to form a data frame, performs ASK modulation on the data frame and transmits the result signal as a modulated downlink signal to the mobile station mounted on the vehicle passing through a tollgate. Here, a method of transmitting a carrier to the mobile station is the same as described above. The mobile station on the vehicle receives the modulated downlink signal, performs demodulation and source decoding on it, analyzes information from the base station and updates its own database, for example, stores final balance obtained after subtracting the toll from current balance.

The configuration and communication method of a mobile station described above can be applied to communication with an arbitrary type fixed apparatus. Similarly, the configuration and communication method of a base station described above can be applied to communication with an arbitrary mobile body.

As described above, according to a mobile communication apparatus and method using backscattering of a carrier, self-synchronization type Manchester coding/decoding is used, thereby realizing high speed data communication and removing the necessity of a special data pattern necessary for frame synchronization. Since the present invention performs ASK modulation using a carrier received from a base station after performing DPSK modulation, a mobile station does not requires a separate oscillator so that hardware configuration can be simplified. Consequently, a mobile station can be economically manufactured. In addition, when an electronic toll collecting system is constructed with a base station and a mobile station according to the present invention, a lot of information necessary for billing can be reliably transmitted between the mobile station mounted on a vehicle and the base station installed at a tollgate at high speed with a low error rate in an operation of automatically collecting a toll imposed on the vehicle moving at high speed.

What is claimed is:

1. A mobile station transmitting data to and receiving data from an external base station at high speed, the mobile station comprising:
a mobile station communication controller for processing data including control data to output a predetermined data frame;
a mobile station source coder for receiving the data frame and performing source coding on it according to a predetermined coding method to output coded data;
a first modulator for receiving a first carrier having a predetermined frequency and modulating the coded signal from the mobile source coder using the first carrier to generate a first modulated signal;
a second modulator for receiving a second carrier having a predetermined frequency and performing modulation on the first modulated signal using the second carrier to generate a modulated uplink signal;
a mobile station interfacer for transmitting the modulated uplink signal to the base station and receiving a modulated downlink signal from the base station;
a first demodulator for receiving and demodulating the modulated downlink signal received from the base station via the mobile station interfacer and outputting demodulated data; and
a mobile station source decoder for performing source decoding on the demodulated data from the first demodulator to convert the demodulated data to a baseband signal.

2. The mobile station of claim 1, wherein the mobile station source coder performs coding according to a Manchester coding method, and the mobile station source decoder performs decoding according to a Manchester decoding method.

3. The mobile station of claim 1, wherein the second carrier is provided from the base station.

4. The mobile station of claim 1, wherein the first modulator performs differential phase shift keying (DPSK) modulation, the second modulator performs amplitude shift keying (ASK) modulation, and the first demodulator performs ASK demodulation.

5. A base station transmitting data to and receiving data from an external mobile station at high speed, the base station comprising:
a base station communication controller for processing data including control data to output a predetermined data frame;
a base station interfacer for receiving a modulated uplink signal from the mobile station and transmitting a modulated downlink signal to the mobile station;
a mixer for mixing the modulated uplink signal with a predetermined intermediate frequency and filtering the mixed signal to convert the modulated uplink signal to a signal having the predetermined intermediate frequency;
an oscillator for generating the predetermined intermediate frequency;
a base station demodulator for demodulating the output signal of the mixer to generate a baseband signal according to a predetermined demodulation method;
a base station source decoder for receiving the baseband signal from the base station demodulator and performing source decoding according to a predetermined method;
a base station source coder for performing source coding the data frame output from the base station communication controller; and
a base station modulator for modulating the output data of the base station source coder according to a predetermined method and outputting modulated data to the base station interfacer.

6. The base station of claim 5, wherein the base station modulator outputs a modulated signal for a predetermined time and then outputs only a carrier having a predetermined frequency until a response is received from the mobile station.

7. The base station of claim 5, wherein the base station demodulator performs differential phase shift keying demodulation, and the base station modulator performs amplitude shift keying modulation.

8. The base station of claim 5, wherein the base station source decoder performs decoding according to a Manchester decoding method, and the base station source coder performs coding according to a Manchester coding method.

9. The base station of claim 5, wherein the base station demodulator comprises:
an amplitude limiting amplifier for receiving the output signal of the mixer and removing noise, thereby outputting a reliable signal;
a phase shifter for shifting the output signal of the amplitude limiting amplifier by a predetermined phase;
a quadrature detection receiver for receiving the output signal of the amplitude limiting amplifier and the output signal of the phase shifter, comparing the two signals to calculate the phase difference between them and filtering a signal corresponding to the calculated phase difference to output the variation of voltage; and
an amplitude comparator for comparing the output signal of the quadrature detection receiver with a predetermined reference value.

10. A data communication method of a mobile station transmitting data to and receiving data from an external base station at high speed, the data communication method comprising the steps of:
processing data including control data to form a predetermined mobile station information data frame;
coding the mobile station information data frame according to a predetermined source coding method and performing primary modulation on the coded data frame using a predetermined first carrier according to a first predetermined modulation/demodulation method;
performing secondary modulation on the primarily modulated signal using a predetermined second carrier according to a second predetermined modulation/demodulation method and transmitting the secondarily modulated signal to the base station;
demodulating a modulated downlink signal transmitted from the base station according to the second predetermined modulation/demodulation method and generating the demodulated signal as a source coded signal; and
decoding the source coded signal according to a predetermined source decoding method to reconstruct original data.

11. The data communication method of claim 10, wherein the step of performing the secondary modulation comprises the step of performing modulation based on the second carrier received from the base station.

12. A data communication method of a base station transmitting data to and receiving data from an external mobile station at high speed, the data communication method comprising the steps of:
receiving a modulated uplink signal transmitted from the mobile station to the base station, mixing the modulated uplink signal with a predetermined intermediate frequency and filtering the mixed signal to generate an intermediate signal having the predetermined intermediate frequency;
demodulating the intermediate signal according to a predetermined demodulation method to generate a baseband signal;
source-decoding the baseband signal according to a predetermined method to reconstruct original data received from the mobile station;
processing data including control data to form a data frame and source-coding the data frame; and
modulating the source coded data frame according to a predetermined method and transmitting the modulated signal to the mobile station.

13. The data communication method of claim 12, wherein in the modulating step, the modulated signal is output for a predetermined time, and then only a carrier having a predetermined frequency is output until there is a response from the mobile station.

14. An electronic toll collecting system for collecting a toll, the electronic toll collecting system comprising a mobile station and a base station, wherein a variety of data including a toll is transmitted and received between the mobile station and the base station at high speed,
the mobile station comprising:
a mobile station communication controller for processing control data and information including start place information and balance to form and output a mobile station information data frame, receiving base station information data including destination information and billing information from the base station, and recalculating and updating the balance;
a mobile station source coder for receiving the mobile station information data frame and performing source coding on it according to a predetermined coding method to output coded data;
a first modulator for receiving a first carrier having a predetermined frequency and modulating the coded signal from the mobile source coder using the first carrier to generate a first modulated signal;
a second modulator for receiving a second carrier having a predetermined frequency and performing modulation on the first modulated signal using the second carrier to generate a modulated uplink signal;
a mobile station interfacer for transmitting the modulated uplink signal to the base station and receiving a modulated downlink signal from the base station;
a first demodulator for receiving and demodulating the modulated downlink signal received from the base station via the mobile station interfacer and outputting demodulated data; and
a mobile station source decoder for performing source decoding on the demodulated data from the first demodulator to generate a baseband signal and transmitting the baseband signal to a base station communication controller,
the base station comprising:
a base station interfacer for receiving a modulated uplink signal from the mobile station and transmitting a modulated downlink signal to the mobile station;
a mixer for mixing the modulated uplink signal with a predetermined intermediate frequency and filtering the mixed signal to generate a signal having the predetermined intermediate frequency;
an oscillator for generating the predetermined intermediate frequency;
a base station demodulator for demodulating the output signal of the mixer to generate a baseband signal;
a base station source decoder for receiving the baseband signal from the base station demodulator and performing source decoding according to a predetermined method;
a base station communication controller for analyzing the mobile station's information data which is decoded and output by the base station source decoder to calculate a toll and processing data link layer control data and base station information data including destination information and billing data to form and output a predetermined base station information data frame;
a base station source coder for performing source coding the base station information data frame; and
a base station modulator for modulating the output data of the base station source coder according to a predetermined method and outputting modulated data to the base station interfacer.

15. The electronic toll collecting system of claim 14, wherein the mobile station source coder and the base station source coder perform coding according to a Manchester coding method, and the mobile station source decoder and the base station source decoder perform decoding according to a Manchester decoding method.

16. The electronic toll collecting system of claim 14, wherein the second carrier is provided from the base station.

17. The electronic toll collecting system of claim 14, wherein the first modulator performs differential phase shift keying (DPSK) modulation, the base station demodulator performs DPSK demodulation, the second modulator and the base station modulator perform amplitude shift keying (ASK) modulation, and the first demodulator performs ASK demodulation.

18. The electronic toll collecting system of claim 14, wherein the base station demodulator comprises:
an amplitude limiting amplifier for receiving the output signal of the mixer and removing noise, thereby outputting a reliable signal;
a phase shifter for shifting the output signal of the amplitude limiting amplifier by a predetermined phase;
a quadrature detection receiver for receiving the output signal of the amplitude limiting amplifier and the output signal of the phase shifter, comparing the two signals to calculate the phase difference between them and filtering a signal corresponding to the calculated phase difference to output the variation of voltage; and
an amplitude comparator for comparing the output signal of the quadrature detection receiver with a predetermined reference value.
